(19) United States
(12) Patent Application Publication
(10) Pub. No.: US 2013/0283673 A1
(43) Pub. Date: Oct. 31, 2013

(54) INSECT TRAPS FOR MATING DISRUPTION OR MONITORING

(71) Applicants: Michael Reinke, Lansing, MI (US); Larry Gut, Haslett, MI (US); Peter McGhee, Holt, MI (US); James Miller, Williamston, MI (US)

(72) Inventors: Michael Reinke, Lansing, MI (US); Larry Gut, Haslett, MI (US); Peter McGhee, Holt, MI (US); James Miller, Williamston, MI (US)

(21) Appl. No.: 13/805,926

(22) PCT Filed: Jul. 6, 2011
(86) PCT No.: PCT/US11/43038

§ 371 Date: Jul. 18, 2013

Related U.S. Application Data
(60) Provisional application No. 61/362,061, filed on Jul. 7, 2010.

(51) Int. Cl. A01M 1/02; A01M 1/10; A01M 1/14

(52) U.S. Cl. CPC A01M 1/026; A01M 1/14; A01M 1/10
USPC 43/114; 43/107

(57) ABSTRACT

An insect trap for mating disruption or monitoring purposes, comprising an at least substantially hollow body for containing an insect-attractant. The body is defined by a plurality of contiguous walls having interior and exterior surfaces, the interior surface of one or more of the plurality of contiguous walls at least partially covered with adhesive. The exterior surfaces define substantially flat faces, and adjacent ones of the plurality of contiguous walls meeting to define edges. At least one opening is defined in each of a majority of the contiguous walls, at least one of the openings being dimensioned to permit the ingress of insects into the interior of the body.

### CROSS-REFERENCE TO RELATED APPLICATIONS

This application is related to, and claims the benefit of priority from, U.S. Provisional Application Ser. No. 61/362,061, filed 7 Jul. 2010, the disclosure of which is incorporated herein by reference in its entirety.

### FIELD OF THE INVENTION

The present invention relates to the field of insect traps and, more particularly, to an insect trap for mating disruption or monitoring.

### BACKGROUND

Mating disruption—the act of dispensing volumes of insect attractants (such as pheromones) into a cropping system as a more ecologically friendly method for controlling unwanted insects—has been an area of study for more than 25 years. The ultimate goal of mating disruption has been to reduce insect populations by inhibiting the insects' ability to discover and orient towards a mate. Many commercial products have been produced over the years to control agricultural pests using this method. One limiting factor in all of the aforementioned products is that their sole method of control is distraction. The pheromone (or other attractant) plume emitted from a dispenser attracts a male insect that, through numerous possible mechanisms, is temporarily removed from the mating population. The key word is “temporarily.” Once a male recovers from the effects of a “fake” pheromone (or other attractant) plume emitted by a mating disruption dispenser, he is capable of finding another plume, whether another “fake” one or a pheromone plume emitted by a potential mate. What is more, research indicates that chance alone dictates whether some insect species will find and orient towards a “fake” or a real pheromone plume. Accordingly, such distraction methods are inadequate solutions to the problem of agricultural insect pests.

Recent research has gone into combining mating disruption and insecticides to create a system of control referred to as “attract and kill.” In such systems, the pheromone or other attractant is used to attract the insect to the attractant source, which has been combined with an insecticide. Contact with the insecticide then kills the insect. There are several problems with these systems, however. First, no commercially available insecticides have been successfully combined with pheromone in a manner that demonstrates adequate killing capability for an entire crop growing season (150-180 days). Second, in order to allow the insect to orient and come in contact with the pheromone source, such a small amount of pheromone is needed that it has proven very difficult to get adequate pheromone release over an extended period of time. Third, the addition of insecticide eliminates the product from being used in organic pest control systems, where mating disruption is a popular form of pest control.

A variant of the “attract and kill” method has been employed for the specific purpose of monitoring, rather than controlling, insect populations. According to such systems, attractants, such as, for example, synthetic pheromones, are used to orient male insects toward a trap, where they are captured.

FIG. 1 depicts an insect monitoring trap of known construction, also referred to as a “delta trap,” comprised of three corrugated plastic sides that connect to form a body of triangular cross-section. A pressed paper liner to which an adhesive is partially applied is slidingly inserted into the trap's interior so that insects (usually moths) come into contact with the adhesive and become stuck thereto. As noted, adhesive is only partially applied to the paper liner. In the delta trap of FIG. 1, the total surface area of the interior, paper liner is 1629 cm². However, only 231 cm² is covered by adhesive.

As traps such as the foregoing are used solely for visually monitoring insect populations, they are placed in the field in very low densities (often as low as one trap every 10 acres). Moreover, the complexities of these traps and the materials needed to allow ease of use and durability under repeated human intervention makes them large and expensive. This limits their extensive placement in and among crops as a means of insect control. Further, wind tunnel experiments demonstrate that conventional monitoring traps have sub-optimal pheromone dispersal. In particular, the pheromone plume emerges out of the traps' large open ends in a narrow stream that does not disperse very much.

### SUMMARY OF THE DISCLOSURE

The specification discloses an insect trap for mating disruption or monitoring purposes, the insect trap comprising an at least substantially hollow body for containing an insect-attractant. The body is defined by a plurality of contiguous walls having interior and exterior surfaces, the interior surface of one or more of the plurality of contiguous walls at least partially covered with adhesive. The exterior surfaces define substantially flat faces, and adjacent ones of the plurality of contiguous walls meet to define edges. At least one opening is defined in each of a majority of the contiguous walls, at least one of the openings being dimensioned to permit the ingress of insects into the interior of the body.

Per one feature, the interior surfaces of at least the majority of the plurality of contiguous walls are substantially covered with adhesive. In an example, but not by way of limitation, the adhesive may be applied directly to the interior surfaces of at least the majority of the walls.

Per another feature of the present invention, the ratio of adhesive-covered interior surfaces to the total internal volume of the hollow body is in the range of from approximately 1.3 to approximately 5.2.

In one form of the insect trap of the present invention, the body defined by the contiguous walls is generally cube-shaped.

Per yet another feature, the plurality of contiguous walls include a bottom wall having an opening therein which is relatively smaller than the remainder of each at least one opening defined in the majority of the contiguous walls. The dimensions of the relatively smaller opening are sufficiently large to facilitate drainage of water from the interior of the body, yet sufficiently small so as to prevent the egress of insects to be trapped from the interior of the body.

Per still a further feature of the present invention, at least one of the plurality of contiguous walls may include a see-through portion permitting viewing of the interior of the body. For instance, at least one of the plurality of contiguous walls may be at least substantially made of a see-through material. Alternatively, at least one of the plurality of contiguous walls may include a window separately formed therein, the window defined by a see-through material.

According to yet another feature, the body may be at least substantially made of a recycled material.

Per still another feature, the body may be at least substantially made of cardboard.

Per a still further feature, the body may be water-resistant.

According to yet another feature, the body may be made of a plastic-coated paperboard material.

Per yet a further feature, the body may be made of plastic.

According to yet another feature, the exterior surface of one or more of the plurality of contiguous walls may be covered with adhesive.

### BRIEF DESCRIPTION OF THE DRAWINGS

For a better understanding of the present invention and to show more clearly how it may be carried into effect, reference will now be made, by way of example, to the accompanying drawings, in which:

FIG. 1 is a color photograph of a prior art monitoring trap shown in an operational environment;

FIGS. 2A through 2C are perspective views of the insect trap of the present invention according to several embodiments thereof;

FIG. 2D depicts one exemplary two-dimensional blank form from which a three-dimensional insect trap according to one embodiment of the present invention may be assembled;

FIG. 3 is a chart depicting the results of a comparative study of the trap of the present invention (“Cube”) and a delta trap (“LPD”) of the prior art;

FIG. 4 is a chart depicting the results of a comparative study of several embodiments of traps per the present invention (“cube”) and a delta trap (“Delta”) of the prior art;

FIG. 5 is a chart depicting the results of a comparative study of traps according to the present invention (“Cube”) and delta traps (“Delta”) of the prior art;

FIGS. 6 through 8 are charts depicting the results of a comparative study of insect traps of the present invention (“microtrap”) and conventional monitoring traps (“Pherocon VI” and “P-II”);

FIG. 9 is a chart depicting the results of a comparative study of the trap of the present invention (“microtrap”) and a monitoring trap of the prior art (“Pherocon VI”) using two different attractant loads (“standard load” and “ 1/10 load”);

FIGS. 10 through 12 are charts depicting the results of a further comparative study of insect traps of the present invention (“microtrap”) and conventional monitoring traps (“Pherocon VI” and “P-II”);

FIG. 13 is a chart depicting the results of a comparative study of the effectiveness of pheromone-loaded traps per the present invention at different densities (“50/acre”, “100/acre”, “200/acre” and “400/acre”) as compared to monitoring traps of the prior art in study plots with (“Isomate”) and without (“Check”) pheromones;

FIG. 14 is a chart depicting the total capture of target insects (codling moths) by traps according to the present invention in the study the results of which are also shown in FIG. 13;

FIG. 15 is a chart depicting the results of a comparative study of several embodiments of traps per the present invention (“Non-stick Trap” and “Sticky Trap”) as compared to monitoring traps of the prior art in study plots with (“Flex 80”) and without (“Check”) pheromones; and

FIG. 16 is a chart depicting the capture of target insects (codling moths) by traps according to the present invention in the study the results of which are also shown in FIG. 15.

### WRITTEN DESCRIPTION

As required, a detailed description of exemplary embodiments of the present invention is disclosed herein. However, it is to be understood that the disclosed embodiments are merely exemplary of the invention, which may be embodied in various and alternative forms. The accompanying drawings are not necessarily to scale, and some features may be exaggerated or minimized to show details of particular components. Therefore, specific structural and functional details disclosed herein are not to be interpreted as limiting, but merely as providing a representative basis for teaching one skilled in the art to variously employ the present invention.

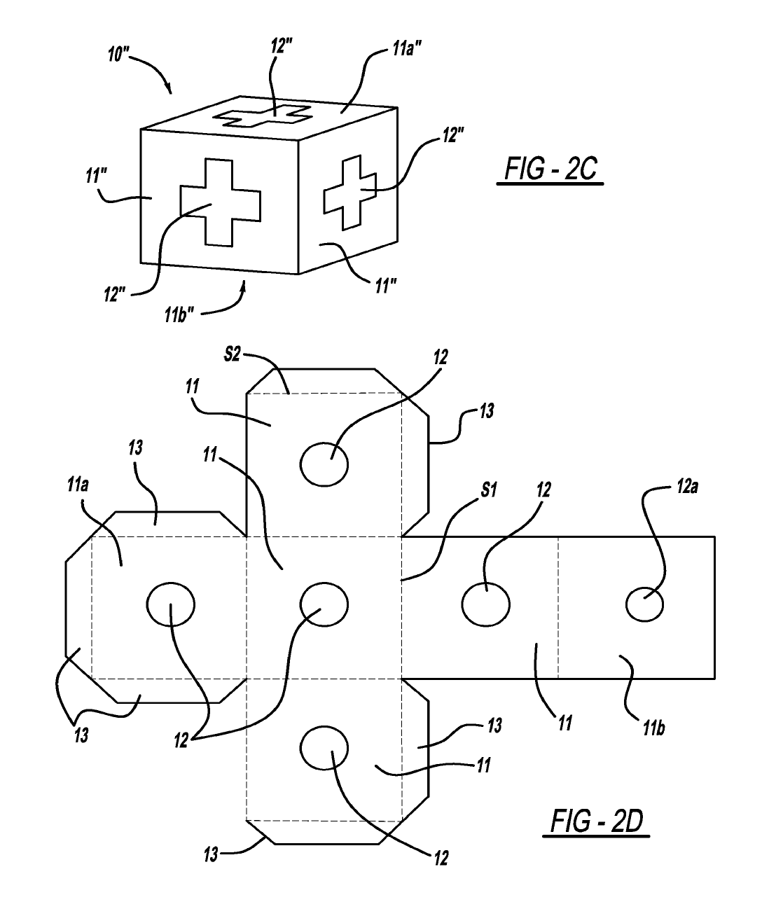

Turning now to the FIG. 2A, the present invention according to an exemplary embodiment may be seen to comprise an insect trap for mating disruption or monitoring purposes, the trap 10 including an at least substantially hollow body for containing an insect-attractant. The body 10 is defined by a plurality of contiguous walls 11 having interior (not visible) and exterior surfaces. Walls 11 define, depending upon the overall shape of the body and its orientation, sidewalls 11, a top wall 11a and a bottom wall 11b. The interior surface of one or more of the plurality of contiguous walls being at least partially covered with an adhesive (such as, by way of non-limiting example, STICKUM (commercially available from Mueller Sports Medicine, Prairie du Sac, Wis.), rosin, non-drying vegetable oil mixtures, polyisobutene, polyisobutene/mineral-oil mixtures, polyisobutane/vegetable-oil mixtures, non-drying hot melt glues, double-sided adhesive tapes, etc.). The adhesive, as will be appreciated by those skilled in the art, is selected to be sufficient to trap one or more insects of a desired type or types (hereafter also referred to as “target insects”). The exterior surfaces define substantially flat faces, and adjacent ones of the plurality of contiguous walls meet to define edges. At least one opening 12 is defined through each of a majority of the plurality of contiguous walls, and at least one of the openings 12 is dimensioned to permit the ingress of at least the target insects into the hollow interior of the body 10.

Optionally, the exterior surface of one or more of the walls may be at least partially covered with adhesive.

As noted, each of a majority of the plurality of walls 11 includes at least one opening 12 therein and, at least in the illustrated embodiments, at least one such opening 12 is provided in each of the plurality of walls 11. It will be appreciated, with the benefit of this disclosure, that a greater number of openings distributed around the walls make the trap omni-directional and, as described below, facilitate attractant dispersal. By comparison, conventional monitoring traps only have openings on the small ends of the trap (the faces that are perpendicular to the long axis of the trap), so attractant dispersal is only effective when the ends of the trap are aligned with the wind direction.

At least one such opening is sized to allow desired target insects (e.g., moths, leaf rollers, curculios, etc., depending upon the insect desired to be trapped) into the inventive trap while excluding debris like flower petals and larger insects that would foul the adhesive on the inside surfaces of the walls. Openings 12 may be of identical or different dimensions, with one or more permitting ingress of desired target insects while excluding unwanted debris.

As discussed below, one or more openings may be provided in any given wall, each opening taking any of a variety of shapes and dimensions, and multiple openings in any given wall being optionally arranged in a variety of patterns. According to the exemplary embodiments described herein, circular openings predominate, in diameters ranging from 5/16″ to ½″. It will be appreciated from this disclosure that opening size, as well as the percentage of open area or frequency of openings are important considerations. The openings cannot be too small so that the target insects are unable to enter the traps through at least one such openings. According to the illustrated embodiments, which were designed for trapping moths, it is desirable that one or more of the openings be larger than the moths since moths constantly flutter their wings. Additionally, it is desirable that the frequency of openings in the walls be such that the target insects can find their way into the traps with relative ease, but not so frequent that the adhesive area on the interior of the traps is reduced to the point that the traps are relatively ineffectual or lack the capacity to trap a meaningful number of insects relative to the overall trap size. Preferably, though not necessarily, the ratio of adhesive-covered interior surface(s) to the total internal volume of the hollow body is in the range of from approximately 1.3 to approximately 5.2.

While the insect trap of the present invention can be formed in any known manner, there is exemplified in FIG. 2D a two-dimensional blank design which can be employed to fabricate an insect trap of the present invention having, in the assembled condition, a cube-shaped body. Per convention, this blank includes 6 square areas defining the six walls: four side walls 11, a top wall 11a and a bottom wall 11b. Score lines S1 define the boundaries between adjacent walls and along which the walls are bent in relation to each other to define the final three-dimensional form. Flaps 13 project from several of the walls as shown, score lines S2 defining the boundaries between such flaps 13 and adjacent walls. Flaps 13 are bent along these score lines S2 to define areas of overlap with certain of the walls in the assembled condition, with adhesive or other means known to those skilled in the art being employed to connect the flaps 13 and these walls in the areas of overlap.

As shown in the embodiment of FIG. 2D, each wall 11, 11a and 11b includes an opening 12 therein. Bottom wall 11b optionally has an opening 12a therein which is relatively smaller than the remainder of each one or more openings 12 defined in the other walls 11, 11a (which openings 12 are depicted in the illustrated embodiment as being essentially the same size). The dimensions of the relatively smaller opening 12a are sufficiently large to facilitate drainage of water from the interior of the body 10, yet sufficiently small so as to prevent the egress of target insects to be trapped from the interior of the body 10.

In operation, a suitable attractant for the target insects (e.g., pheromone bait) is added to the hollow interior of the trap to attract (typically male) insects, which are then trapped on the adhesive-covered interior surface(s). The attractant may, by way of non-limiting example, be a natural or synthetic sex-pheromone specific for the target insect (which attractants are known to those skilled in the art), a natural or synthetic plant volatile or fermentation product, also known to those skilled in the art, combinations thereof, etc. Preferably, though not necessarily, the attractant is loaded in a controlled-release dispenser suitable to release the attractant for a period of time appropriate to the crop being protected from the target insect(s). Such information respecting conventional dispensers and required time periods is known to those skilled in the art. As described below, the attractant may be provided on a rubber (natural rubber, butyl rubber, etc.) septum or, as is also known in the art, on cotton wick, in lengths of polyethylene/ethylene vinyl acetate tubing sealed at the ends, etc.

Relative to dispersal of the attractant, the manipulation of airflow is effected by the one or more openings in the wall(s) of the trap and the overall shape of the body. To this end as well, the size, shape and number of openings in the trap, as well as the shape of the body, are important considerations. By experimentation, the inventors hereof have discovered that non-spherical bodies with plural openings result in the release of more attractant.

To show the effect of opening shape on airflow, three designs were tested. Each of the three trap designs was 3″ square. In one trap 10, shown in FIG. 2A, a single ⅝″ hole 12 was provided in each wall 11. In the second trap 10′, shown in FIG. 2B, four 7/16″ openings 12′ were provided in each wall 11′, the openings in each wall spaced equidistant from each other in a “square” pattern. In the third trap 10″, shown in FIG. 2C, a single cross-shaped opening 12″ was provided in each wall 11″, each arm of the cross being 0.75″ long and 25″ wide.

In the center of each trap was placed a cotton wick saturated with titanium tetrachloride (TiCl₄). TiCl₄ forms a visible vapor cloud of hydrochloric acid upon contact with water, permitting visual examination of air patterns created by a particular insect trap design. Regardless of trap orientation, air would enter the opening or openings on an upwind wall of the insect trap and exit from all remaining openings on the other walls of the trap. In each case, this created a singular, cohesive plume larger than the trap itself.

When testing different opening designs, the overall size of the empty space per wall influenced the amount of air passing through the trap. With an opening cross-section of 2 cm², for instance, the trap with a single opening on each wall (FIG. 2A) had a plume that would occasionally break up and was not evenly distributed around the trap. The trap with four openings (FIG. 2B) on each wall (4 cm²) had, by comparison, a much more pronounced and even plume. The trap with the single cross-shaped opening (FIG. 2C) on each wall (4.5 cm²) had a slightly more concentrated plume than the others.

It was further observed that openings on walls of the trap not facing into the wind improve attractant disbursal, presumably because of the Bernoulli Effect—that is, attractant (e.g., pheromone) is sucked out of openings by wind passing over those walls of the insect trap not facing into the wind. This leads to the dispersal of a larger scent cone and, presumably, better attraction of target insects to the trap.

Preferably, though not necessarily, the insect trap of the present invention is manufactured from biodegradable materials, such as, by way of non-limiting example, paper products, including cardboard, and/or plastics, including bioplastics (e.g., starch biopolymers, polylactates, etc.), so that the traps would not need to be removed from their operational environment (e.g., the field) following use.

Preferably, though not necessarily, the body is also, or alternatively, at least substantially made of a recycled material (paper, plastic, etc.).

In one embodiment, the body is at least substantially made of cardboard, recycled or not.

Additionally, or in the alternative, the body is water-resistant, being made, for example and without limitation, of a plastic-coated or wax-coated paperboard material.

Optionally, at least one of the walls of the body may be transparent to permit viewing the interior of the trap. This may be accomplished, for instance, by providing at least one of the plurality of contiguous walls with a see-through portion permitting viewing of the interior of the body. Such a see-through portion may be defined by substantially making at least one of the plurality of contiguous walls from a see-through material. Alternatively, or in addition, such a see-through portion may be defined by including a separately formed window in at least one of the plurality of contiguous walls, the window defined by a see-through material.

Optionally, the body may be of a color which is attractive to the target insects and, preferably (though not necessarily), not attractive to non-targeted insects.

### EXPERIMENTAL EXAMPLE

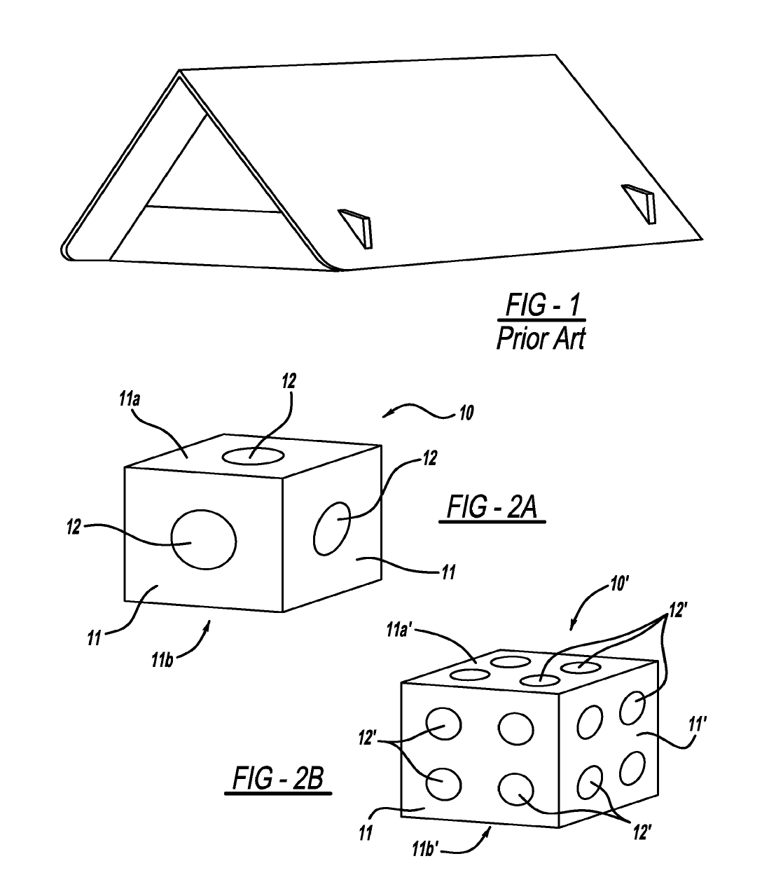

In a comparative study against a conventional delta trap, such as described above in reference to FIG. 1, the insect trap of the present invention demonstrated favorably. More particularly, as shown in Table I, below, four different insect trap designs according to the present invention (three comprising 1″ square cubes having in each of the walls thereof openings with one of three diameters, 5/16″, ⅜″ or ½″; one comprising a 1.5″ square cube having in each wall thereof an opening of ½″ diameter) exhibited percent-capture rates from 25% to 60% from among a defined population of target insects. The comparative delta trap exhibited a percent-capture rate of 46.2%.

TABLE I

| | | | | Percent | | |
|---|---|---|---|---|---|---|
| Trap type | Cube size | Hole dia. | n | on trap | in trap | capture |
| cube | 1″ | 5/16″ | 10 | 100 | 50 | 50 |
| cube | 1″ | ⅜″ | 10 | 70 | 60 | 60 |
| cube | 1″ | ½″ | 16 | 75 | 44 | 25 |
| cube | 1.5″ | ½″ | 16 | 63 | 44 | 44 |
| delta | | | 52 | 71.2 | 57.7 | 46.2 |

### EXPERIMENTAL EXAMPLE

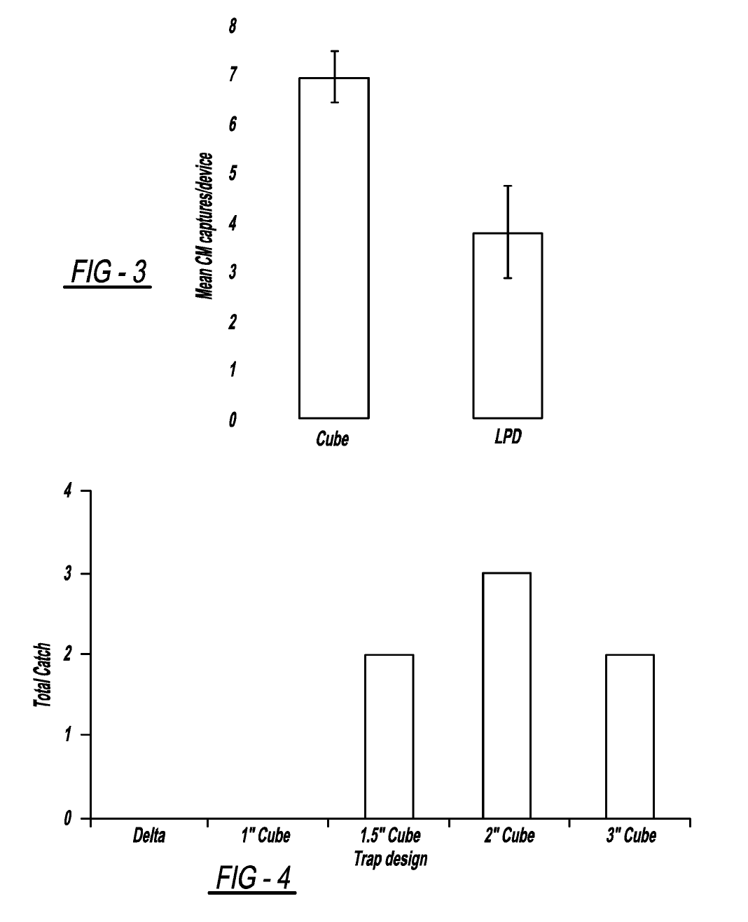

In a field trial of the present invention, six identical, 1.5″ square insects traps, each with a 0.5″ diameter opening in each wall, were set up in a randomized, complete block design. For comparison, six identical prior art delta traps were set up, also in a randomized, complete block design. All traps were placed in the field for a single night. As shown in the chart of FIG. 3, the mean catch of the traps of the present invention was 7 codling moths per trap, significantly higher than the mean catch of 3.8 codling moths in the delta traps of the prior art.

### EXPERIMENTAL EXAMPLE

To test the effects of overall size on insect catch, inventive insects traps of four different sizes were tested against a prior art delta trap of the type described hereinabove. The inventive insect traps tested had the following dimensions: 1″ square, 1.5″ square, 2″ square and 3″ square. All of the inventive traps had single, 0.5″ diameter openings defined in each wall thereof. All traps were placed in the field for one night of target insect (moth) flight. All traps were baited with commercially available rubber septa loaded with 0.1 mg codling moth pheromone. As shown in FIG. 4, the mean catch of the inventive traps was seven codling moths per trap, a result significantly higher than the delta traps' mean catch of 3.8 codling moths per trap.

### EXPERIMENTAL EXAMPLE

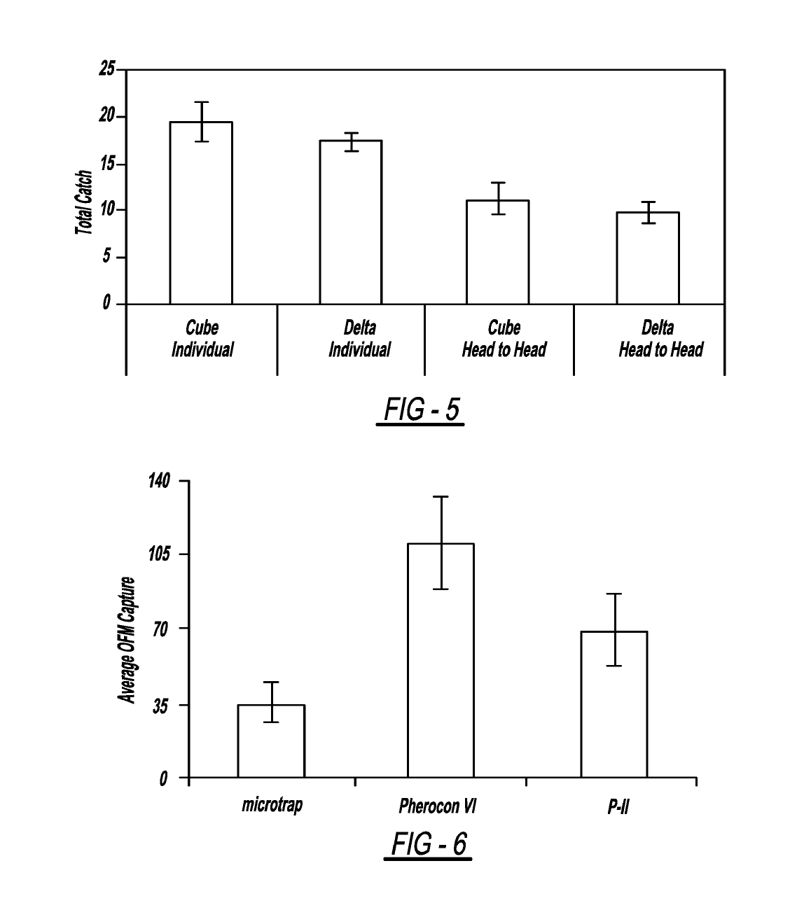

In a further field experiment, 16 large field cages were constructed in an abandoned orchard. Cage dimensions were 20 m wide by 20 m long and 5 m tall. Each cage covered 12 trees. In each of 5 cages was placed a single insect trap according to the present invention. In each of 5 cages was placed a single prior art delta trap of the type described hereinabove. In each of the remaining 6 cages were placed a single insect trap according to the present invention and a single prior art delta trap such as described above. The inventive traps were 2″ square with a single 11/16″ diameter hole in each wall. All traps, both the traps of the present invention and the delta traps, were baited with commercially available rubber septa loaded with 0.1 mg codling moth pheromone. Evenly released throughout each cage were 36 lab-reared codling moths. As shown in the chart of FIG. 5—wherein the labels “cube individual” and “delta individual” refer to the results from cages containing one or the other type of trap, and the labels “cube head to head” and “delta head to head” refer to the results from cages containing both types of traps—the insect traps of the present invention caught as many insects as the prior art delta traps.

### EXPERIMENTAL EXAMPLE

In a further field experiment using the experimental cage setup described immediately above, 36 oriental fruit moth males were released evenly into each of 4 cages. In each of two of the four cages were placed three prior art delta traps, evenly spaced apart. In each of the remaining two cages were placed three insect traps according to the present invention, also evenly spaced apart. The inventive traps for this experiment were 2″ square with a single 0.5″ diameter opening provided in each wall. All traps, both those of the present invention and the prior art delta traps, were baited with commercially available rubber septa loaded with 0.1 mg oriental fruit moth pheromone. As shown in Table II, below, the traps of the present invention caught as many insects as the delta traps (83% of the fruit moth population in each cage).

TABLE II

| | | | moths | Percent |
|---|---|---|---|---|
| Trap Type | Cage 1 | Cage 2 | released | recapture |
| Delta | 32 | 28 | 38 | 83.3 |
| Cube | 33 | 27 | 36 | 83.3 |

### EXPERIMENTAL EXAMPLES

In a further comparative study between an insect trap according to the present invention and conventional, commercially available insect traps—namely, the TRÉCÉ PHEROCON VI monitoring trap (commercially available from TRÉCÉ, INC, Adair, Okla.) and a generic equivalent of the TRÉCÉ PHEROCON II monitoring trap (the PHEROCON II being commercially available from TRÉCÉ, INC, Adair, Okla.)—5 single-trap replicates were performed in established apple orchards. Each replicate consisted of a single insect trap per the present invention, a single TRÉCÉ PHEROCON II-equivalent monitoring trap and a single TRÉCÉ PHEROCON VI monitoring trap placed in tress at least 10 meters apart. Each insect trap (those of the present invention and those of the prior art) was loaded with approximately the same amount of attractant (pheromone).

Once during each week of the study, the individual traps were rotated within their replicate to minimize the effect of trap placement on the experimental results.

The target insects for the study were oriental fruit moths, obliqueband leafrollers and codling moths.

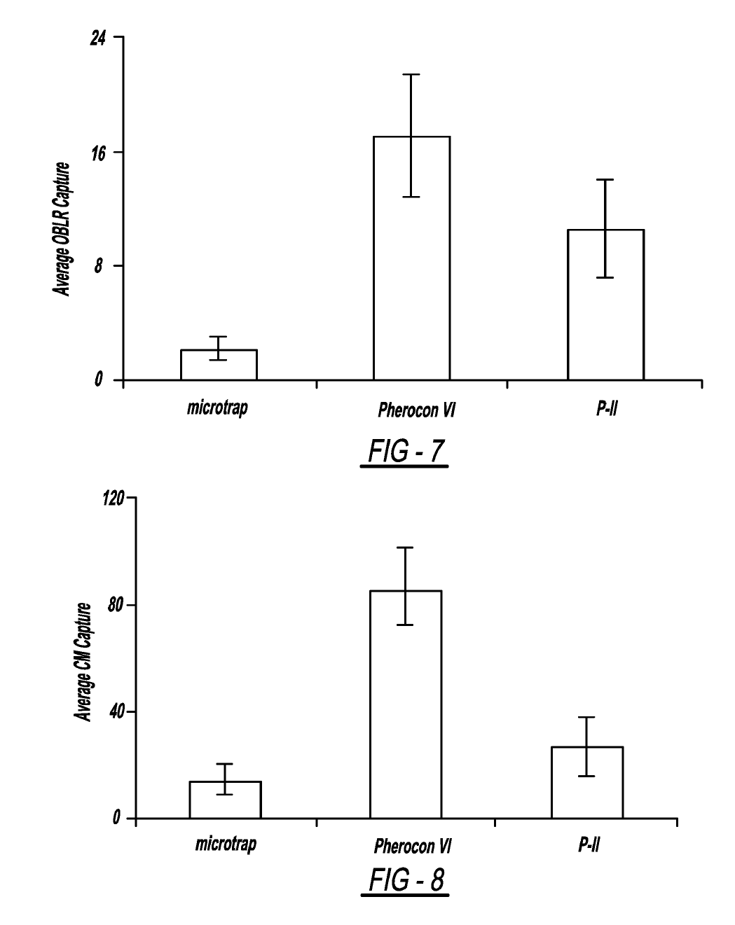

Referring to the charts of FIGS. 6, 7 and 8, the insect trap of the present invention (labeled “microtrap”) was successful at capturing the target insects (labeled “OBLR” for obliqueband leafrollers, “OFM” for oriental fruit moths, and “CM” for codling moths).

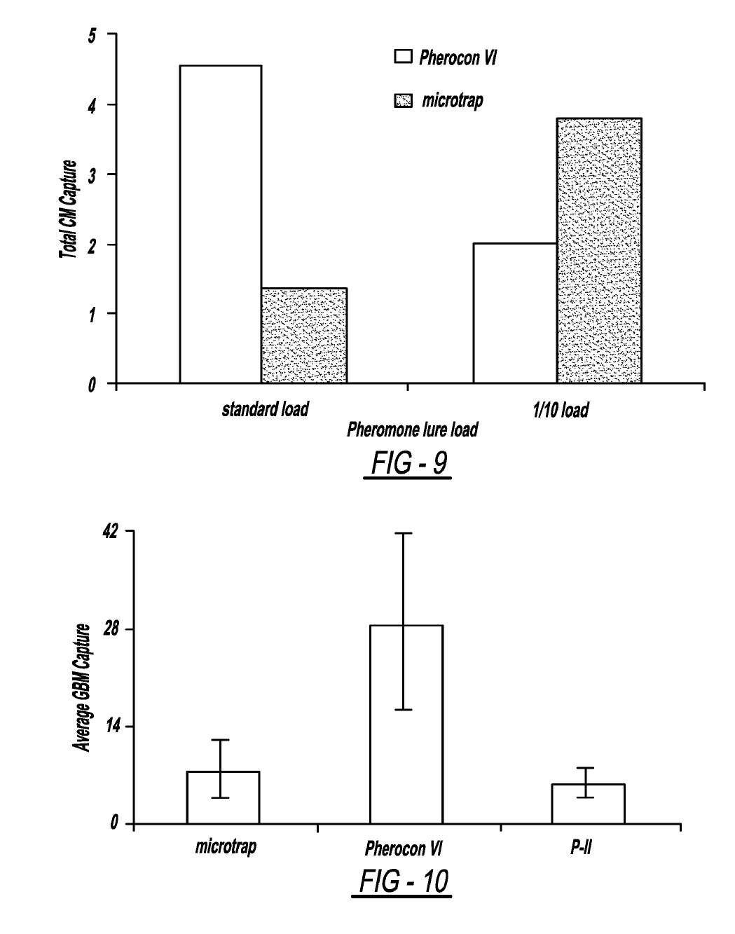

In view of the relatively low numbers of target insects captured in the foregoing study, a further comparative experiment was conducted between an insect trap according to the present invention and the TRÉCÉ PHEROCON VI monitoring trap of the prior art. In this study, different amounts of the attractant (pheromone, in this example) were tested in each trap (both those of the prior art and those of the present invention). More particularly, each of the TRÉCÉ PHEROCON VI monitoring trap and the insect trap of the present invention were tested with the same “standard load,” as well as with an attractant load of approximately 1/10 that amount. As evidenced by the chart in FIG. 9, the insect trap of the present invention trapped significantly more codling moths (labeled “CM” in FIG. 9) than the TRÉCÉ PHEROCON VI monitoring trap when using the 1/10th pheromone load. Without wishing to be bound to any particular theory, the inventors hereof speculate that the results exemplified in FIGS. 6 through 9, reflect the improved attractant release occasioned by the design of the present invention. More specifically, it is speculated that the design of the present invention is so efficient at distributing attractant that the quantity of the “standard load” of the experimental study was overpowering to the target insects and so prevented more insects from entering the trap; whereas, on the other hand, the 1/10th attractant load resulted in a satisfactory amount of attractant release despite the significantly-reduced quantity thereof loaded in the trap.

### EXPERIMENTAL EXAMPLE

In a still further comparative study between an insect trap according to the present invention and conventional, commercially available insect traps—namely, the TRÉCÉ PHEROCON VI monitoring trap and a generic equivalent of the TRÉCÉ PHEROCON II (monitoring trap—5 single-trap replicates were placed in each of grape and blueberry fields. Each replicate consisted of a single insect trap per the present invention, a single TRÉCÉ PHEROCON II-equivalent monitoring trap and a single TRÉCÉ PHEROCON VI monitoring trap placed in tress at least 10 meters apart. Each insect trap was loaded with approximately the same amount of attractant (pheromone, in this example).

Once during each week of the study, the individual traps were rotated within their replicate to minimize the effect of trap placement on the experimental results.

The targeted species for this study were grape berry moths for the grape fields, and cherry fruitworms and cranberry fruitworms for the blueberry fields.

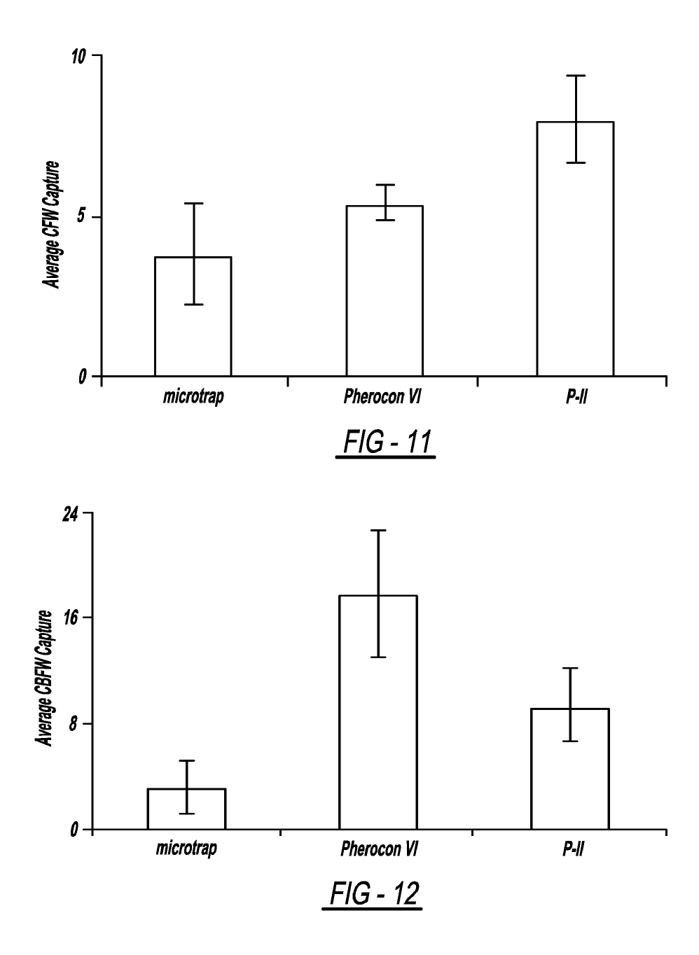

Referring to the charts of FIGS. 10, 11 and 12, the insect trap of the present invention (labeled “microtrap”) was successful at capturing the target species (labeled “GBM” in FIG. 10 for grape berry moths, “CFW” in FIG. 11 for cherry fruitworms, and “CBFW” in FIG. 12 for cranberry fruitworms).

### EXPERIMENTAL EXAMPLE

In a still further study, the effectiveness of different rates of insect traps according to the present invention at capturing codling moths versus conventional monitoring traps was evaluated in test plots. Each test plot consisted of 25 freestanding apple trees in a 5×5 arrangement (covering approximately 0.1 acres). Each of four replicates was completed within a single test plot to remove the effects of tree variety, age, or resident pest population levels. Treatments included an untreated test plot (no pheromone, four rates, or densities, of inventive insect traps determined as a number of traps per acre (50/acre, 100/acre, 200/acre and 400/acre), and one treatment of a standard mating disruption pheromone, ISOMATE FLEX (commercially available from PACIFIC BIOCONTROL CORP., Litchfield Park, Az.), without a trap (i.e., just pheromone dispersal). Conventional monitoring traps were positioned in each test plot.

The spacing of the trees in each test plot dictated the placement of the inventive insect traps. At the two lowest densities (50/acre and 100/acre) a maximum of 1 trap was placed in each tree. At the 200/acre density, each tree in the test plot included one of the inventive insect traps, while approximately 50% of the trees in the test plot included one additional inventive insect trap (for a total of 2 traps in such trees). At the highest density (400/acre) each tree in the test plot included 2 or 3 of the inventive insect traps.

During the course of the study, all of the inventive insect traps were checked weekly for the capture of codling moths.

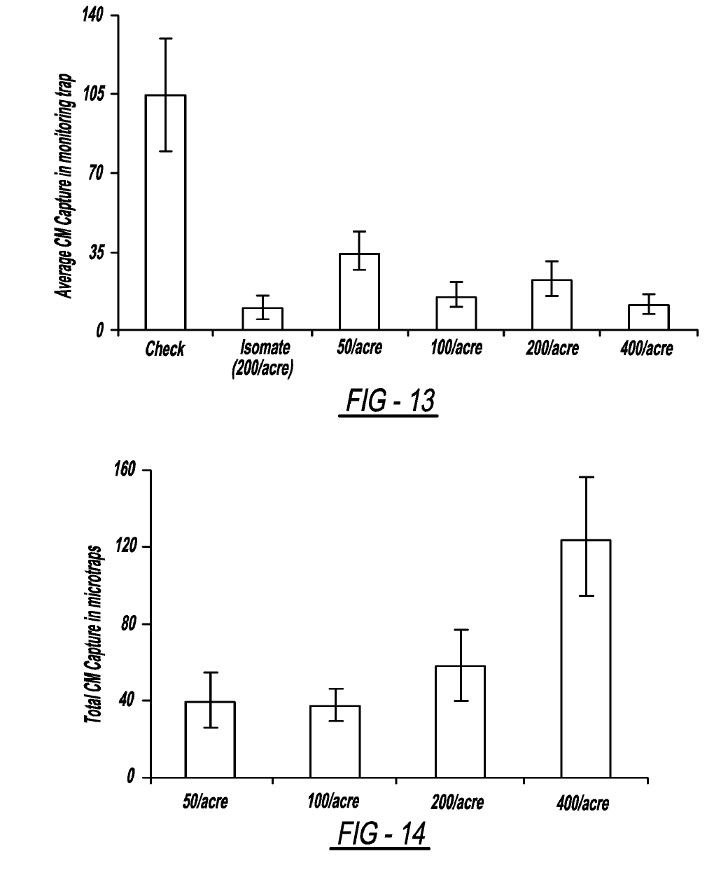

As shown in the charts of FIGS. 13 and 14, of which FIG. 13 depicts the average codling moth capture in the conventional monitoring traps for each treatment (i.e., no pheromone (labeled “Check” in FIG. 13), the disruption pheromone (labeled “Isomate” in FIG. 13), and the four densities)) and FIG. 14 depicts the total codling moth capture for the four densities of the inventive insect traps, all four densities (50/acre, 100/acre, 200/acre and 400/acre) of the inventive insect trap were successful in capturing codling moths in the test plots (FIG. 14) and, thus, in reducing codling moth capture in the conventional monitoring traps (FIG. 13).

It is notable from FIG. 14 that the total number of codling moths captured for the three lower densities (50/acre, 100/acre and 200/acre) were similar, while the highest density (400/acre) demonstrated an appreciable increase in codling moth capture.

### EXPERIMENTAL EXAMPLE

In another study, the effectiveness of different densities of insect traps according to the present invention at capturing codling moths versus a standard mating disruption pheromone, ISOMATE FLEX, without a trap (i.e., just pheromone dispersal), was evaluated in test plots.

For this study, four treatments were investigated, one each in one of four 0.5 acre test plots in an apple orchard. The four treatments included an untreated test plot (no pheromone), one treatment of a standard mating-disruption pheromone, ISOMATE FLEX, without a trap (i.e., just pheromone dispersal), one treatment of inventive insect traps with adhesive, and one treatment of inventive insect traps without adhesive (to evaluate the present invention as purely a mating disruption device). All pheromone treatments (ISOMATE FLEX and the insect traps of the present invention) were applied at the density of 200 sources per acre. Conventional monitoring traps were positioned in each test plot.

During the course of the study, all of the inventive insect traps were checked weekly for the capture of codling moths.

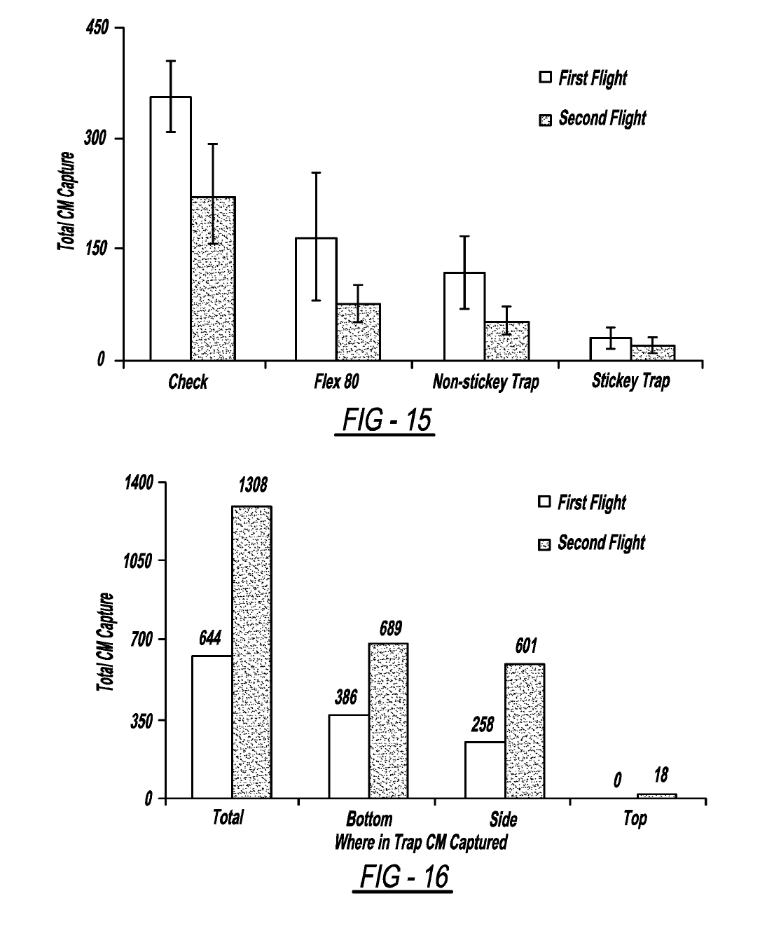

As shown in the charts of FIGS. 15 and 16, of which FIG. 15 depicts the average codling moth capture in the conventional monitoring traps for each treatment (i.e., no pheromone (labeled “Check” in FIG. 15), the disruption pheromone (labeled “Flex 80” in FIG. 15), the inventive traps with no adhesive (labeled “Non-sticky Trap” in FIG. 15), and the inventive traps with adhesive (labeled “Sticky Trap” in FIG. 15)) and FIG. 16 depicts the total codling moth capture for the inventive insect traps with adhesive, the inventive insect trap was successful in capturing codling moths in the test plots (FIG. 16), and superior to the application of pheromone alone in mating disruption (FIG. 15).

It is notable from FIGS. 15 and 16 that, during the course of this study, the pheromone lures were changed between first and second codling moth flights, with the subsequent lures releasing a lower amount of pheromone. Accordingly, separate results are identified in the charts of these figures: Results for the “First Flight” (i.e., at the higher pheromone load; and results for the “Second Flight” (i.e., at the lower pheromone load). As noted above, the inventors hereof surmise—without desiring to be bound by any particular theory—that, by virtue of its design, the insect trap of the present invention disperses more pheromone than conventional insect traps. As such, these and other experimental results disclosed herein evidence the increased effectiveness of the present invention with lower pheromone loads than are conventionally employed. This is shown in the results of FIGS. 15 and 16, from which it is manifest that the insect traps of the present invention caught more insects at the lower pheromone load.

FIG. 16 further provides data respecting the location within the inventive insect traps (with adhesive) where codling moths were captured (i.e., the interior, adhesive-covered bottom, side and top walls), along with the total number of codling moths captured in these traps. As evidenced by these data, the number of codling moths captured on the interior surface of the top (labeled “Top”) wall was negligible. Accordingly, it is at least optional, though not necessary, that the application of adhesive to at least the top interior surface of the top wall of insect traps according to the present invention may be foregone, such as, for instance, to reduce the overall cost of each such insect trap. Of course, it is contemplated that adhesive may be applied to any one or more interior surfaces of the walls of insect traps of the present invention, depending upon the extent of insect capture desired.

By the foregoing, the present invention provides an insect trap for monitoring or mating disruption which is at once simple in its construction and operation, provides improved pheromone disbursal as compared to prior art devices, thereby increasing baiting efficiency, permits variability to select for target insects, lowers the need for insecticide use, can be used in IPM systems—so that spraying is required only when traps are catching males above a threshold number/trap, and may allow orchard managers to limit spraying only to ‘hot spots’ where a hatch has occurred within the orchard. Relatedly, it will be appreciated that, by virtue of its relatively low cost, the present invention can be employed in greater numbers in a given location (such as, for instance, an orchard), thereby facilitating with more accuracy areas within such location where pest insect activity is higher. This will permit more targeted, and therefore economical, application of any additional insect control measures that may be warranted.

The foregoing descriptions of the exemplary embodiments of the invention have been presented for purposes of illustration and description. They are not intended to be exhaustive of, or to limit the invention to, the precise form disclosed, and modifications and variations thereof are possible in light of the above teachings or may be acquired from practice of the invention. The illustrated embodiments are shown and described in order to explain the principals of the innovation and its practical application so as to enable one skilled in the art to utilize the innovation in these and various additional embodiments and with various modifications as are suited to the particular use contemplated. Although only a few exemplary embodiments of the present invention have been described in detail in this disclosure, those skilled in the art who review this disclosure will readily appreciate that many modifications are possible without materially departing from the novel teachings and advantages of the subject matter herein recited. Accordingly, all such modifications are intended to be included within the scope of the present innovations. Other substitutions, modifications, changes and omissions may be made in the design, operating conditions and arrangement of the exemplary embodiments without departing from the spirit of the present invention.

The invention in which an exclusive property or privilege is claimed is defined as follows:

1. An insect trap for mating disruption or monitoring purposes, comprising an at least substantially hollow body for containing an insect-attractant, the body defined by a plurality of contiguous walls having interior and exterior surfaces, the interior surface of one or more of the plurality of contiguous walls at least partially covered with adhesive, the exterior surfaces defining substantially flat faces, and adjacent ones of the plurality of contiguous walls meeting to define edges, and at least one opening defined in each of a majority of the contiguous walls, at least one of the openings being dimensioned to permit the ingress of insects into the interior of the body.

2. The insect trap of claim 1, wherein the interior surfaces of at least the majority of the plurality of contiguous walls are substantially covered with adhesive.

3. The insect trap of claim 2, wherein the adhesive is applied directly to the interior surfaces of at least the majority of the walls.

4. The insect trap of claim 1, wherein the ratio of adhesive-covered interior surfaces to the total internal volume of the hollow body is in the range of from approximately 1.3 to approximately 5.2.

5. The insect trap of claim 1, wherein the body of the insect trap defined by said contiguous walls is generally cube-shaped.

6. The insect trap of claim 1, wherein the plurality of contiguous walls include a bottom wall having an opening therein which is relatively smaller than the remainder of each at least one opening defined in the majority of the contiguous walls, the dimensions of said relatively smaller opening being sufficiently large to facilitate drainage of water from the interior of the body, yet sufficiently small so as to prevent the egress of target insects to be trapped from the interior of the body.

7. The insect trap of claim 1, wherein at least one of the plurality of contiguous walls includes a see-through portion permitting viewing of the interior of the body.

8. The insect trap of claim 7, wherein at least one of the plurality of contiguous walls is at least substantially made of a see-through material.

9. The insect trap of claim 7, wherein at least one of the plurality of contiguous walls includes a window separately formed therein, the window defined by a see-through material.

10. The insect trap of claim 1, wherein the body is at least substantially made of a recycled material.

11. The insect trap of claim 1, wherein the body is at least substantially made of cardboard.

12. The insect trap of claim 1, wherein the body is water-resistant.

13. The insect trap of claim 1, wherein the body is made of a plastic-coated paperboard material.

14. The insect trap of claim 1, wherein the body is made of plastic.

15. The insect trap of claim 1, wherein further the exterior surface of one or more of the plurality of contiguous walls is at least partially covered with adhesive.

16. An insect trap for mating disruption or monitoring purposes, comprising an at least substantially hollow body for containing an insect-attractant, the body defined by a plurality of contiguous walls having interior and exterior surfaces, at least one of the exterior surfaces defining a substantially flat face, the interior surface of one or more of the plurality of contiguous walls at least partially covered with adhesive so that the ratio of adhesive-covered interior surfaces to the total internal volume of the hollow body is in the range of from approximately 1.3 to approximately 5.2, and at least one opening defined in each of a majority of the contiguous walls, at least one of the openings being dimensioned to permit the ingress of insects into the hollow interior of the body.

17. The insect trap of claim 16, wherein the plurality of contiguous walls each define a substantially flat face, and adjacent ones of the plurality of contiguous walls meet to define edges.

18. The insect trap of claim 17, wherein the body of the insect trap defined by said contiguous walls is generally cube-shaped.

19. The insect trap of claim 16, wherein the plurality of contiguous walls include a bottom wall having an opening therein which is relatively smaller than the remainder of each at least one opening defined in the majority of the contiguous walls, the dimensions of said relatively smaller opening being sufficiently large to facilitate drainage of water from the interior of the body, yet sufficiently small so as to prevent the egress of target insects from the interior of the body.

20. The insect trap of claim 16, wherein the adhesive is applied directly to the interior surface of one or more of the walls.

21. The insect trap of claim 16, wherein at least one of the plurality of contiguous walls includes a see-through portion permitting viewing of the interior of the body.

22. The insect trap of claim 21, wherein at least one of the plurality of contiguous walls is at least substantially made of a see-through material.

23. The insect trap of claim 21, wherein at least one of the plurality of contiguous walls includes a window separately formed therein, the window defined by a see-through material.

24. The insect trap of claim 16, wherein the body is at least substantially made of a recycled material.

25. The insect trap of claim 16, wherein the body is at least substantially made of cardboard.

26. The insect trap of claim 16, wherein the body is water-resistant.

27. The insect trap of claim 16, wherein the body is made of a plastic-coated paperboard material.

28. The insect trap of claim 16, wherein the body is made of plastic.

29. An insect trap for mating disruption or monitoring purposes, consisting essentially of a hollow body for containing an insect-attractant, the body defined by a plurality of contiguous walls having interior and exterior surfaces, the interior surface of one or more of the plurality of contiguous walls at least partially covered with adhesive, at least one of the exterior surfaces defining a substantially flat face, and adjacent ones of the plurality of contiguous walls meeting to define edges, and at least one opening defined in each of a majority of the contiguous walls, at least one of the openings being dimensioned to permit the ingress of insects into the hollow interior of the body.

30. The insect trap of claim 29, wherein the plurality of contiguous walls each define a substantially flat face, and adjacent ones of the plurality of contiguous walls meet to define edges.

31. The insect trap of claim 30, wherein the body of the insect trap defined by said contiguous walls is generally cube-shaped.

32. The insect trap of claim 29, wherein the interior surfaces of at least the majority of the plurality of contiguous walls are substantially covered with adhesive.

33. The insect trap of claim 32, wherein the adhesive is applied directly to the interior surfaces of at least the majority of the walls.

34. The insect trap of claim 29, wherein the ratio of adhesive-covered interior surfaces to the total internal volume of the hollow body is in the range of from approximately 1.3 to approximately 5.2.

35. The insect trap of claim 29, wherein the plurality of contiguous walls include a bottom wall having an opening therein which is relatively smaller than the remainder of each at least one opening defined in the majority of the contiguous walls.

36. The insect trap of claim 29, wherein at least one of the plurality of contiguous walls includes a see-through area permitting viewing of the interior of the body.

37. The insect trap of claim 36, wherein at least one of the plurality of contiguous walls is at least substantially made of a see-through material.

38. The insect trap of claim 36, wherein at least one of the plurality of contiguous walls includes a window separately formed therein, the window defined by a see-through material.

39. The insect trap of claim 29, wherein the body is at least substantially made of a recycled material.

40. The insect trap of claim 29, wherein the body is at least substantially made of cardboard.

41. The insect trap of claim 29, wherein the body is water-resistant.

42. The insect trap of claim 29, wherein the body is made of a plastic-coated paperboard material.

43. The insect trap of claim 29, wherein the body is made of plastic.
